(19) United States
(12) Patent Application Publication
(10) Pub. No.: US 2011/0194620 A1
(43) Pub. Date: Aug. 11, 2011

(54) VIDEO DISPLAYING ADJUSTING DEVICE

(75) Inventor: Steven TSAI, Taipei County (TW)

(73) Assignee: HERAN CO., LTD., Taoyuan County (TW)

(21) Appl. No.: 12/957,648

(22) Filed: Dec. 1, 2010

(30) Foreign Application Priority Data
Feb. 9, 2010 (TW) 099202716

(51) Int. Cl. H04N 7/12

(52) U.S. Cl. 375/240.26; 375/E07.076

(57) ABSTRACT

A video displaying adjusting device has at least two signal source terminals, a displaying device, and a remote control. The displaying device has video decoder units, image reduction/expansion units, a microcomputer control unit, and an image processing unit. The video decoder units receive signals from the signal source terminals and transmits the signals to the image reduction/expansion units where the signals are arranged to form reduced/expanded windows, which are controlled by the microcomputer control unit. The image processing unit performs an overlapping process on the arranged reduced/expanded windows and they are then displayed on a screen. The remote control uses a reduction/expansion device to communicate with the microcomputer control unit of the displaying device. The reduction/expansion device can control the sizes and locations of the arranged reduced/expanded windows from the microcomputer control unit. The remote control performs control over the displaying of the windows.

### BACKGROUND OF THE INVENTION

1. Field of the Invention

The present invention is related to a video displaying adjusting structure, and more particular to a design in which a displaying device comprises an image expansion/reduction unit built therein and a remote control comprises an expansion/reduction control device to allow a screen that is in displaying to perform arbitrary reduction/expansion of size of a window through an operation made by the expansion/reduction control device, so that the present invention offers a function of adjusting vide displaying and is applicable to various LCD (Liquid Crystal Display) televisions, LCD displays, or the likes.

2. Description of Related Art

The development of society and progress of technology bring changes to the displaying technology of television from the early age cathode ray tube (CRT) television to the modern television era of LCD television and plasma display panel (PDP) television. The displaying quality gets into the era of full high definition (HD). This progress allow people to enjoy the best video entertainment ever had. For the early televisions, the screen of each television can only show a single channel or program on the screen, but the recently developed televisions provide various advanced technologies of displaying, including Picture-in-Picture (PIP), Picture-on-Picture (POP), and Picture-and-Picture (PAP), which allow a viewer to watches images from two different signal sources. For a television having dual tuners built therein, programs of two channels of cable television (CATV) can be watched at the same time.

Dual window displaying for the currently available LCD televisions is subjected to certain technical limitations for displaying. For example, a PIP television shows a secondary window on a corner of a screen surface, usually the upper right corner; a POP television shows two windows of the same size on the left and right portions of the screen surface; and a PAP television shows one large window and one small window. The location and size of the windows displayed on the television screen are fixed and a user cannot perform an operation to control the locations of the two windows or to change the window size of displaying area for the secondary window. This causes certain troubles in viewing or enjoying audio/video contents.

Further, besides CATV program signals that are received through a coaxial cable and digital television (DTV) program signals transmitted through satellites, the currently available sources of television signal include signals received through an input device (such as digital visual interface (DVI), high definition multimedia interface (HDMI), RGB primary color connection interface, separate video (S-video) connector, and D-subminiature (D-sub) VGA interface) of an LCD television. All the programs can only be conveyed to a viewer by renting a channel from a CATV provider and transmitting the programs through a coaxial cable to an LCD television of the viewer. However, a lot of captioned messages, such as instant information, railway schedule, high-speed railway schedule, information message, text and animation messages or scrolling banner, are not allowed to directly display on an LCD television. This causes inconvenient and impractical issues of contents displaying.

In view of these problems, the present invention aims to provide a video displaying adjusting device that allows for reduction/expansion of a screen window as desired for easy operation by a television viewer.

### SUMMARY OF THE INVENTION

Accordingly, the primary objective of the present invention is to provide a video displaying adjusting structure, which uses a remote control to control windows displayed on a screen and to perform arbitrary change of locations and reduction/expansion of the windows so as to enhance overall practicability and convenience of operation.

The secondary objective of the present invention is to provide a video displaying adjusting structure, which comprises signal source terminals that respectively receive signals from multiple sources and display multiple windows on a screen to allow for easy pre-viewing by a viewer and thus enhance overall convenience.

In order to achieve the foregoing objectives, the present invention provides a video displaying adjusting structure, which comprises at least two signal source terminals, a displaying device, and a remote control. The displaying device comprises video decoder units, image reduction/expansion units, a microcomputer control unit, and an image processing unit. The video decoder units receive signals from the signal source terminals and transmit the signals to the image reduction/expansion units where the signals are arranged to form reduced/expanded windows. The reduction/expansion of the windows is controlled by the microcomputer control unit. The image processing unit performs an overlapping process on the arranged reduced/expanded windows that are formed of the signals from the signal source terminals and the overlapped windows are then displayed on a screen. The remote control comprises a reduction/expansion device, which is in signal communication with the microcomputer control unit of the displaying device, whereby the reduction/expansion control unit is operable to control the sizes and locations of the arranged reduced/expanded windows from the microcomputer control unit. As such, the remote control performs control over the displaying of the windows to realize arbitrary reduction/expansion and arrangement of the windows, which shows various pieces of information supplied from the signal source terminals.

### BRIEF DESCRIPTION OF THE DRAWINGS

The present invention can be fully understood from the following detailed description and preferred embodiment with reference to the accompanying drawings, in which:

FIG. 1 is a schematic view illustrating an architecture of a vide displaying adjusting device according to the present invention;

FIG. 2 is a schematic view illustrating the video displaying adjusting device according to the present invention performing reduction/expansion of a window on a screen; and

FIG. 3 is a schematic view illustrating the video displaying adjusting device according to the present invention performing movement of a window on a screen.

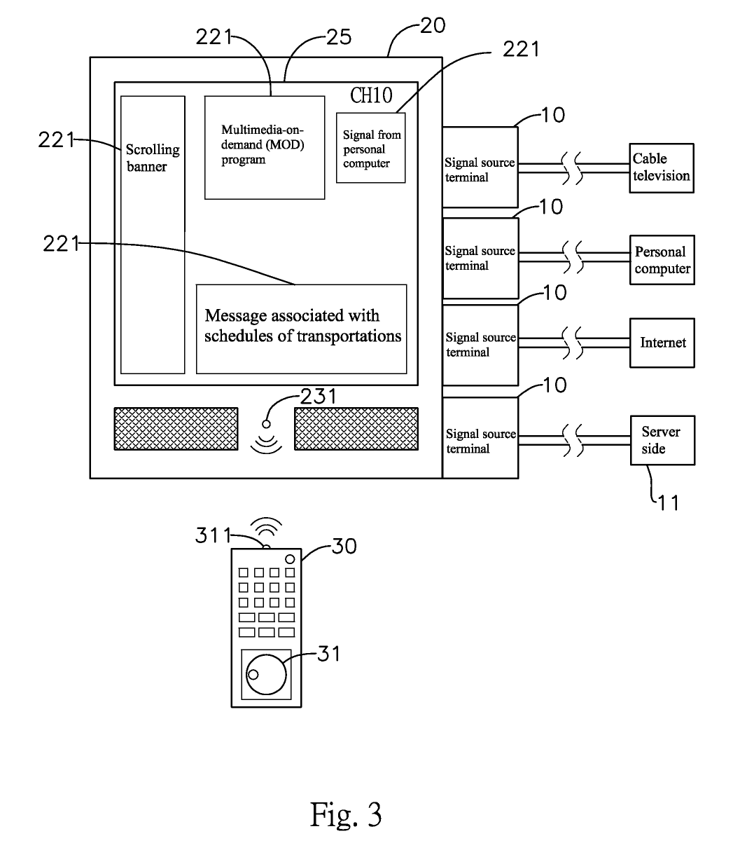

### DETAILED DESCRIPTION OF THE PREFERRED EMBODIMENTS

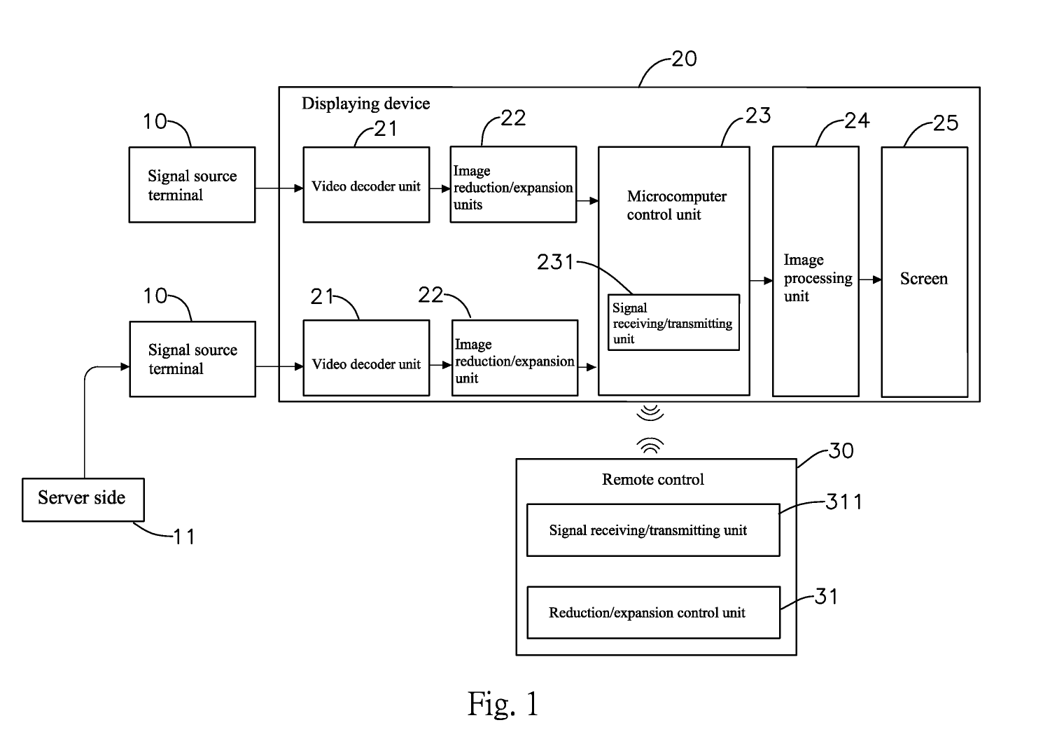

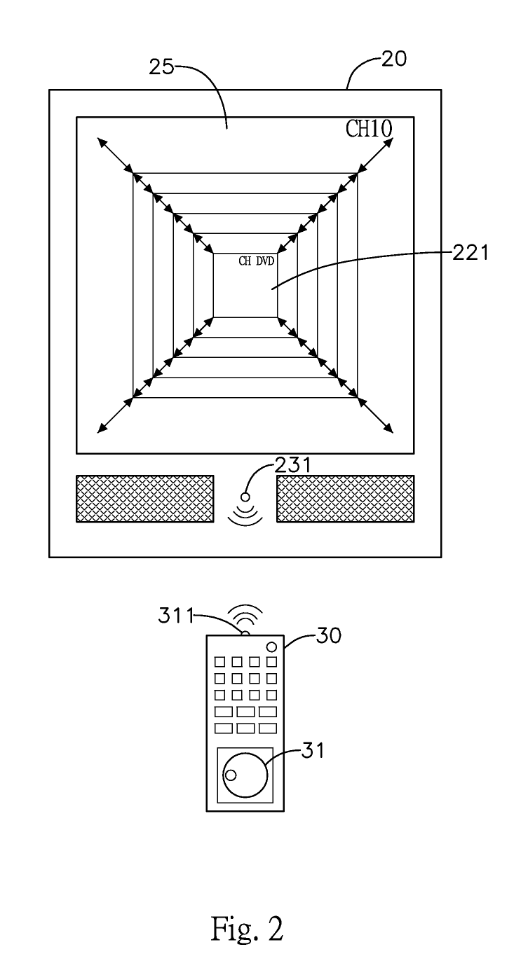

With reference to the drawings and in particular to FIGS. 1 and 2, the present invention provides a video displaying adjusting device, which comprises at least two signal source terminals 10, a displaying device 20, and a remote control 30. The signal source terminals 10 transmit signals through for example coaxial cables, digital antennas, DVI interfaces, HDMI interfaces, D-sub interfaces, S-vide interfaces, USB (Universal Serial Bus) interfaces, Bluetooth interfaces, infra-red (IR) interfaces, and Internet interfaces. The signals received through the signal source terminals 10 include CATV programs, radio-wave programs, self-produced programs, self-produced information channels, video/audio signals from video/audio displaying devices, multimedia-on-demand (MOD) programs, and signals from personal computers. The information channels are loaded in a server side and are transmitted through any one of the signal source terminals 10 to the displaying device 20. The information loaded in the server side 11 includes advertisements, scrolling banners, message associated with schedules of transportations, publicity of laws and regulations, instantaneous messages, text messages, and animation messages. These signals can be received simultaneously from multiple sources or received as a single message. The displaying device 20 comprises video decoder units 21, image reduction/expansion units 22, a microcomputer control unit 23, and an image processing unit 24. The video decoder units 21 receive signals from the signal source terminals 10. The vide decoder units 21 can be arranged in one-to-one fashion to correspond to the signal source terminals 10 or in a one-to-multiple fashion to correspond to the signal source terminals 10 in order to decode and convert input signals into video signals. The vide decoder units 21 transmit the converted signals to the image reduction/expansion units 22, which arrange the signals into reduced/expanded windows 221. The windows 221 can be handled in such a way that multiple windows 221 are opened based on multiple sets of signals received and then the microcomputer control unit 23 operates to control the reduction/expansion of the windows 221. When a reduction/expansion instruction is received, the microcomputer control unit 23 carries out arrangement and reduction/expansion of an associated widow 221 and then the vide processing unit 24 performs an overlapping process on the arranged reduced/expanded windows 221 that are from various signal source terminals, so as to simultaneously arrange the multiple windows 221 on the same screen 25 and then the overlapped windows 221 are displayed on the screen for instantaneous and convenient viewing to thereby enhance overall convenience. The remote control 30 comprises a reduction/expansion control unit 31, which is in signal communication with the microcomputer control unit 23 of the displaying device 20. The reduction/expansion control unit 31 of the remote control 30 and the microcomputer control unit 23 of the displaying device 20 comprise signal receiving/transmitting units 231, 311 respectively. These signal receiving/transmitting units 231, 331 transmit signals to each other through for example radio wave transmission, infrared transmission, laser transmission to realize transmission of encoded signals. The reduction/expansion control unit 31 of the remote control 30 is operable to control the sizes and locations of the arranged reduced/expanded windows 221 from the microcomputer control unit 23 so that the windows displayed on the screen 25 can be set at any desired locations with any desired sizes. Preferably, the reduction/expansion control unit 31 of the remote control 30 comprises an intelligent shuttle-wheel knob, which allows for control of the sizes of the windows through rotary motion, or a roller that controls the sizes of the windows through sliding motion. As such, the remote control 30 performs control over displaying of the windows 221 for arbitrary reduction/expansion and arrangement of the windows 221, while the windows 221 display various pieces of information from different signal source terminals 10.

To this point, it can be appreciated that the present invention offers the following advantages:

(1) Windows shown on a displaying screen can be easily handled through the reduction/expansion control unit of a remote control for reduction/expansion of the windows and vertical and horizontal movements of the locations of the windows to thereby enhance the convenience and practicability of the operation.

(2) Multiple signal sources are provided for simultaneously supplying signals from different sources to allow for simultaneously displaying multiple windows on the same screen to thereby improve the diversification and viewability of information.

What is claimed is:

1. A video displaying adjusting device comprises:
at least two signal source terminals;
a displaying device, which comprises video decoder units, image reduction/expansion units, a microcomputer control unit, and an image processing unit, the video decoder units receiving signals from the signal source terminals and transmitting the signals to the image reduction/expansion unit for arranging the signals into reduced/expanded windows, the microcomputer control unit controlling the reduction/expansion of the windows, the image processing unit performing an overlapping process on the arranged reduced/expanded windows that are formed of the signals from the signal source terminals, the overlapped windows being then displayed on a screen; and
a remote control, which comprises a reduction/expansion control unit, which is in signal communication with the microcomputer control unit of the displaying device, whereby the reduction/expansion control unit is operable to control sizes and locations of the arranged reduced/expanded windows from the microcomputer control unit;
whereby the remote control performs control over displaying of the windows for arbitrary reduction/expansion and arrangement of the windows, while the windows display various pieces of information from different signal source terminals.

2. The video displaying adjusting device according to claim 1, wherein the signal source terminals transmit signals through coaxial cables, digital antennas, DVI interfaces, HDMI interfaces, D-sub interfaces, S-vide interfaces, USB interfaces, Bluetooth interfaces, infra-red interfaces, and Internet interfaces.

3. The video displaying adjusting device according to claim 1, wherein the signals received through the signal source terminals include CATV programs, radio-wave programs, self-produced programs, self-produced information channels, video/audio signals from video/audio displaying devices, multimedia-on-demand (MOD) programs, and signals from personal computers.

4. The video displaying adjusting device according to claim 3, wherein the information channel is loaded in a server side and includes advertisements, scrolling banners, message associated with schedules of transportations, publicity of laws and regulations, instantaneous messages, text messages, and animation messages.

5. The video displaying adjusting device according to claim 1, wherein the reduction/expansion of windows on the displaying device is controlled through a reduction/expansion control device to realize arbitrary reduction/expansion on the screen.

6. The video displaying adjusting device according to claim 1, wherein the locations of windows on the displaying device are controlled through a reduction/expansion control device to realize arbitrary setting on the screen.

7. The video displaying adjusting device according to claim 1, wherein the reduction/expansion control device of the remote control comprises an intelligent shuttle-wheel knob, which allows for control of the sizes of the windows through rotary motion.

8. The video displaying adjusting device according to claim 1, wherein the reduction/expansion control unit of the remote control comprises a roller that controls the sizes of the windows through sliding motion.

9. The video displaying adjusting device according to claim 1, wherein the reduction/expansion control unit of the remote control and the microcomputer control unit of the displaying device comprise signal receiving/transmitting units, which transmit signals to each other through radio wave transmission, infrared transmission, laser transmission to realize transmission of encoded signals.
